(19) United States
(12) Patent Application Publication
(10) Pub. No.: US 2012/0075480 A1
(43) Pub. Date: Mar. 29, 2012

(54) VIDEO TESTING SYSTEM AND METHOD

(75) Inventors: YU-KAI XIONG, Shenzhen (CN); XIN LU, Shenzhen (CN); SHIH-FANG WONG, Tu-Cheng (TW); FEI WANG, Shenzhen (CN); XIN-HUA LI, Shenzhen (CN); DONG-SHENG LV, Shenzhen (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/053,042

(22) Filed: Mar. 21, 2011

(30) Foreign Application Priority Data
Sep. 24, 2010 (CN) 201010289328.1

(51) Int. Cl. H04N 17/00

(52) U.S. Cl. 348/181; 348/E17.001

(57) ABSTRACT

A video testing system tests the performance of a video player. The video player plays a predetermined video having video characteristics that correspond to the to-be-tested performance of the video player. The testing system includes a capturing member, a decomposition unit, an analysis unit, and a determination unit. The capturing member captures the video played by the video player. The decomposition unit decomposes the captured video into a sequence of frames according to a predetermined playback speed of the video player. The analysis unit selects frames of the captured video, and compares the selected frames to analyze video characteristic parameters of the captured video. The determination unit determines whether there is a difference between the video characteristic parameters of the captured video and standard characteristic parameters of the predetermined video is below a predetermined range to obtain the performance of the video player.

### BACKGROUND

1. Technical Field

The present disclosure relates to device testing, and more particularly to a video testing system and method for testing the performance of a video player.

2. Description of Related Art

After a video player is manufactured, the performance of the video player needs to be tested. The test generally involves a person viewing a predetermined video on the video player and determining the performance of the video player. Because this involves a human tester, the results of different tests may not be consistent when using different testers.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of a video testing system in accordance with an embodiment.

FIG. 2 is a flowchart of a video testing method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

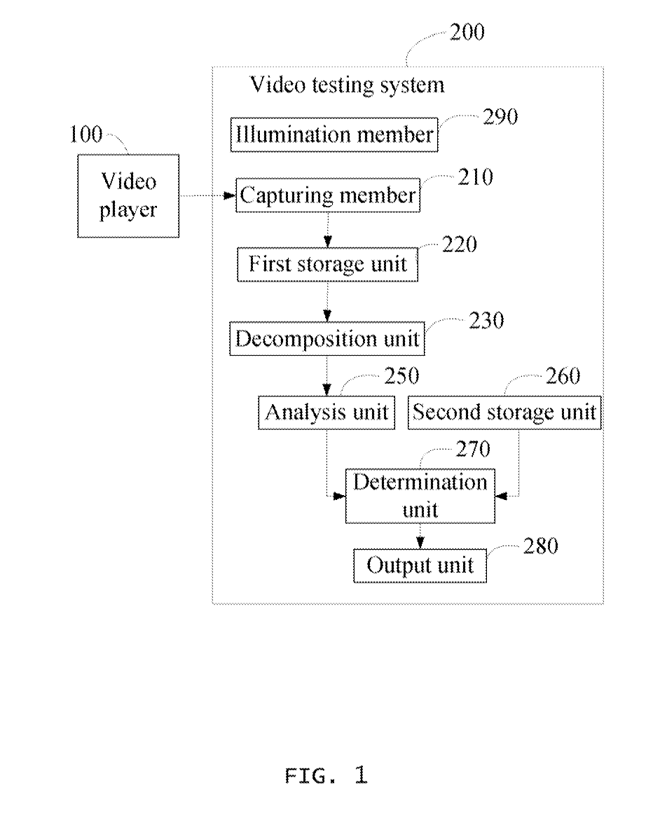

Referring to FIG. 1, a video testing system 200 is used for testing the performance of a video player 100. The video player 100 is used for playing a predetermined video, and generating a start up signal when the predetermined video starts playing. The predetermined video has video characteristics corresponding to the to-be-tested performance of the video player 100. For example, if the smoothness of the video player 100 is to be tested, the predetermined video is sorted into pairs of sequential frames having the same features, that is, at least one feature of each pair of sequential frames is the same.

The video testing system 200 includes a capturing member 210, a first storage unit 220, a decomposition unit 230, an analysis unit 250, a second storage unit 260, a determination unit 270, and an output unit 280.

The capturing member 210 is used for capturing the video played by the video player 100 in response to the start up signal. An interval between a first time when the video player 100 begins to play the predetermined video and a second time when the capturing member 210 begins to capture the played video is short enough to allow the capturing member 210 to capture all the video played by the video player 100.

The first storage unit 220 is used for storing the captured video for accessing at a later time.

The decomposition unit 230 is used for decomposing the captured video into a sequence of frames according to a predetermined playback speed of the video player 100. In the embodiment, the predetermined playback speed of the video player 100 is 23 frames per second; accordingly, the decomposition unit 230 decomposes the captured video into 23 frames per second.

The analysis unit 250 is used for selecting frames of the captured video according to a predetermined rule, and comparing the selected frames to analyze video characteristic parameters of the captured video. In the embodiment, each pair of sequential frames of the captured video are selected and compared for analyzing similarity between each pair of sequential frames to estimate the smoothness of the captured video. The predetermined rule is determined based on the video characteristics of the predetermined video.

The second storage unit 260 is used for storing the standard characteristic parameters of the predetermined video, such as the similarity between each pair of sequential frames. The video characteristics of the predetermined video can be changed according to the to-be-tested performance of the video player 100. The second storage unit 260 and the first storage unit 250 may be two independent memory chips, or two parts of the same memory chip.

The determination unit 270 is used for determining whether there is a difference between the video characteristics of the captured video and the standard characteristic parameters of the predetermined video is below a predetermined range. If the difference between the video characteristics of the captured video and the standard characteristic parameters of the predetermined video is below the predetermined range, the performance of the video player 100 is acceptable. If the difference between the video characteristics of the captured video and the standard characteristic parameters of the predetermined video is above the predetermined range, the performance of the video player 100 is not acceptable.

The output unit 280 is used for providing the performance of the video player 100 acquired by the determination unit 270 via at least one medium of visual and/or audio output. As such, the user only need view the information provided by the output unit 280 to know the performance of the video player 100, but need not participate in the actual testing process.

For providing a stable test environment, the video player 100 and the video testing system 200 can be arranged in a closed room to be shielded from outside light. In addition, the video testing system 200 further includes an illumination unit 290 in the closed room for providing a stable light environment, thus the video testing system 200 can obtain a stable video data source. The angle and brightness of the illumination unit 290 can be adjusted.

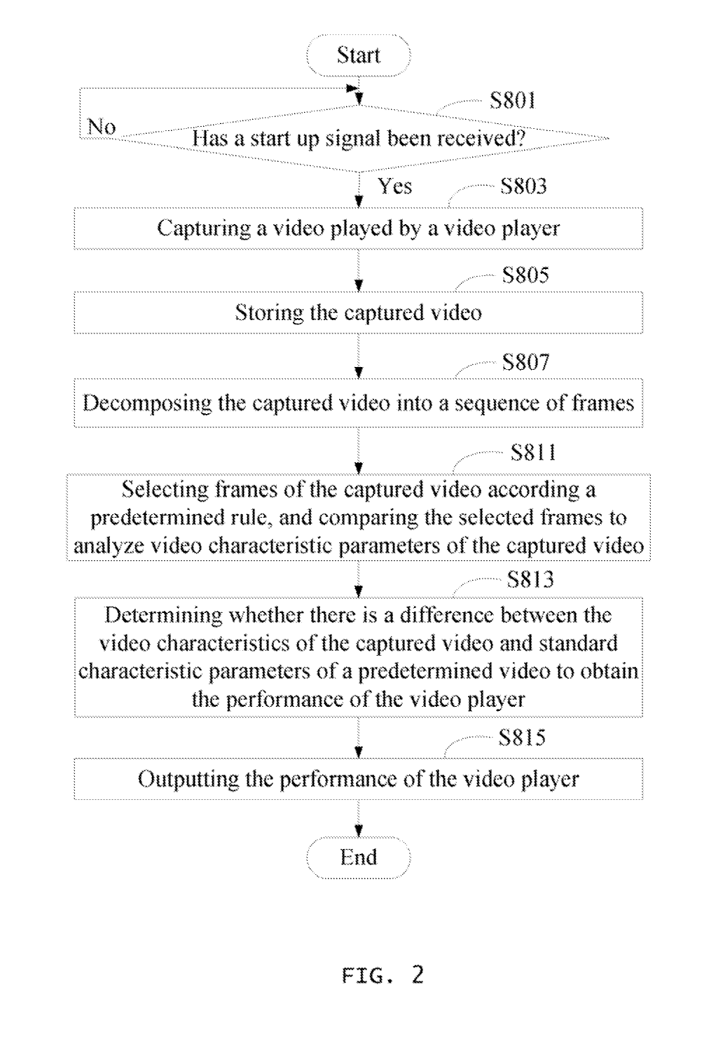

Referring to FIG. 2, a video testing method is provided for testing the performance of a video player. The video player is used for playing a predetermined video, and generating a start up signal when the predetermined video starts playing. The predetermined video has video characteristics corresponding to the to-be-tested performance of the video player. For example, if the smoothness of the video player is to be tested, the predetermined video is sorted into pairs of sequential frames having the same features, that is, at least one feature of each pair of sequential frames is the same. The video testing method includes following steps.

In step S801, it is determined whether a start up signal has been received. If the start up signal has been received, step S803 is implemented. If the start up signal has not been received, step S801 is repeated.

In step S803, a video played by a video player is captured.

In step S805, the captured video is stored to be accessed later.

In step S807, the captured video is decomposed into a sequence of frames according to a predetermined playback speed of the video player. In the embodiment, the predetermined playback speed of the video player is 23 frames per second; accordingly, the captured video is decomposed into 23 frames per second.

In step S811, frames of the captured video are selected according to a predetermined rule, and are compared to analyze video characteristic parameters of the captured video. In the embodiment, each pair of sequential frames are selected and are compared for analyzing the similarity between the two sequential frames to estimate the smoothness of the captured video. The predetermined rule is determined based on the video characteristics of the predetermined video.

In step S813, it is determined whether there is a difference between the video characteristic parameters of the captured video and standard characteristic parameters of the predetermined video is below a predetermined range. If the difference between the video characteristics of the captured video and the standard characteristic parameters of the predetermined video is below the predetermined range, the performance of the video player is acceptable. If the difference between the video characteristics of the captured video and the standard characteristic parameters of the predetermined video is above the predetermined range, the performance of the video player is not acceptable.

In step S815, the performance of the video player is delivered to the user via at least one medium of visual and/or audio output. As such, the user only need view the delivered information to know the performance of the video player, and need not participate in the actual testing process.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A video testing system adapted to test the performance of a video player, the video player being used for playing a predetermined video and generating a start up signal when the predetermined video starts playing, the predetermined video having video characteristics corresponding to the to-be-tested performance of the video player; the video testing system comprising:
a capturing member capturing the video played by the video player in response to the start up signal;
a decomposition unit decomposing the captured video into a sequence of frames according to a predetermined playback speed of the video player;
an analysis unit selecting frames of the captured video according to a predetermined rule, and comparing the selected frames to analyze video characteristic parameters of the captured video;
a determination unit determining whether there is a difference between the video characteristic parameters of the captured video and standard characteristic parameters of the predetermined video is below a predetermined range to obtain the performance of the video player; and
an output unit delivering the performance of the video player.

2. The video testing system according to claim 1, wherein the performance of the video player is acceptable when the difference between the video characteristics of the captured video and the standard characteristic parameters of the predetermined video is below the predetermined range; and the performance of the video player is not acceptable if the difference between the video characteristics of the captured video and the standard characteristic parameters of the predetermined video is above the predetermined range.

3. The video testing system according to claim 1, wherein an interval between a first time when the video player begins to play the predetermined video and a second time when the capturing member begins to capture the played video is short to allow the capturing member to capture all the video played by the video player.

4. The video testing system according to claim 1, wherein the analysis unit selects pairs of sequential frames of the captured video, and compares the selected frames to analyze the similarity between each pair of sequential frames to obtain the smoothness of the captured video.

5. The video testing system according to claim 1, wherein the video testing system and the video player are arranged in a closed room to be shielded from outside light.

6. The video testing system according to claim 5, further comprising an illumination unit in the closed room for providing a stable light environment.

7. The video testing system according to claim 6, wherein brightness of the illumination unit is capable of being adjusted.

8. The video testing system according to claim 6, wherein angle of the illumination unit is capable of being adjusted.

9. A video testing method for testing the performance of a video player, the video player being used for playing a predetermined video and generating a start up signal when the predetermined video starts playing, the predetermined video having video characteristics corresponding to the to-be-tested performance of the video player, the video testing method comprising:
determining whether a start up signal has been received;
if the start up signal has been received, capturing a video played by a video player;
decomposing the captured video into a sequence of frames according to a predetermined playback speed of the video player;
selecting frames of the captured video according to a predetermined rule, and comparing the selected frames to analyze video characteristic parameters of the captured video;
determining whether there is a difference between the video characteristic parameters of the captured video and standard characteristic parameters of the predetermined video is below a predetermined range to obtain performance of the video player; and
delivering the performance of the video player.

10. The video testing method according to claim 9, wherein the performance of the video player is acceptable when the difference between the video characteristics of the captured video and the standard characteristic parameters of the predetermined video is below the predetermined range; and the performance of the video player is not acceptable if the difference between the video characteristics of the captured video and the standard characteristic parameters of the predetermined video is above the predetermined range.

11. The video testing method according to claim 9, wherein the predetermined rule is that pairs of sequential frames of the captured video are selected, and similarity between each pair of sequential frames are analyzed to obtain the smoothness of the captured video.

12. The video testing method according to claim 9, further comprising:
if the start up signal has not been received, the step of determining whether a start up signal has been received is repeated.
